(19) United States
(12) Patent Application Publication
(10) Pub. No.: US 2010/0020295 A1
(43) Pub. Date: Jan. 28, 2010

(54) METHOD TO FABRICATE PATTERN IN HOUSING

(75) Inventors: GUI-YUN YANG, Shenzhen City (CN); JEN-LUNG HUANG, Shindian (TW); CHAO-HSUN LIN, Taipei (TW); BIN LI, Shenzhen City (CN); RUI LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/503,922

(22) Filed: Jul. 16, 2009

(30) Foreign Application Priority Data
Jul. 23, 2008 (CN) 200810302956.1

(51) Int. Cl. G03B 29/00

(52) U.S. Cl. 355/29

(57) ABSTRACT

A method to fabricate a pattern on a housing, includes following steps: placing a film having a first lightproof area and a first light-transmissible area on a housing having light-sensitive inks formed in surface; radiating light on the film and light passing through the light-transmissible area and solidifying the light-sensitive inks; removing the film from the housing and cleaning the un-solidified light-sensitive inks; wiredrawing first wires in the housing and forming first wires in exposed area correspondingly; covering part of the first wires and wiredrawing second wires, the second wires crosses with part of the first wires.

### BACKGROUND

1. Technical Field

The present disclosure relates to a method to fabricate a pattern in a housing.

2. Description of Related Art

With developments of electronic products, consumers have being paying more attention to the external appearance of electronic products. It appears that the electronic products having knit-like pattern housings are highly desirable. A typical method to fabricate a knit-like pattern on a housing is to hot press or mold. In the process of hot pressing, a fabric is heated in combination with molten resin and hot-pressed until the fabric integrally interlocks with the resin. During molding, a film having knit-like pattern is disposed into a mold and injection molded with a resin. However, these methods need to be implemented at a high temperature and a high pressure, the fabric and the film may be easily distorted to produce a low-quality electronic product.

Therefore, there is room for improvement within the art.

### BRIEF DESCRIPTION OF THE DRAWING

Many aspects of the present method to fabricate pattern in housing can be better understood with reference to the following drawings. The components in the various drawings are not necessarily drawn to scale, the emphasis instead being placed upon clearly illustrating the principles of the present method to fabricate pattern in housing. Moreover, in the drawings, like reference numerals designate corresponding parts throughout the diagrams.

FIG. 1 is a planer, isometric view of a film according to an exemplary embodiment.

FIG. 2 is a planer, isometric view of a housing according to an exemplary embodiment.

FIG. 3 is an isometric view of the housing in area III shown in FIG. 2 after first wire drawing.

FIG. 4 is a planer isometric view of another film according to an exemplary embodiment.

FIG. 5 is an isometric view of the housing in area III shown in FIG. 2 after second wire drawing.

### DETAILED DESCRIPTION OF THE EMBODIMENT

An exemplary method to fabricate pattern in housing can be applied to housings of mobile phones and other portable electronic devices. The method may include the following steps.

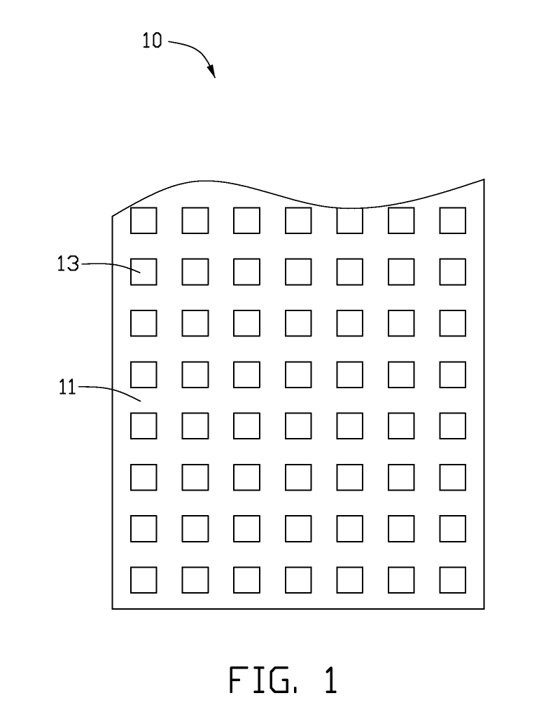

FIG. 1 shows a step of providing a first film 10. The first film 10 has a continuous first lightproof area 11 and a plurality of first light-transmissible areas 13 arranged in a matrix. The first lightproof area 11 has light-sensitive materials adhered thereto, such as opaque light-sensitive glues. The first light-transmissible areas 13 can be transparent/translucent excluding light-sensitive materials.

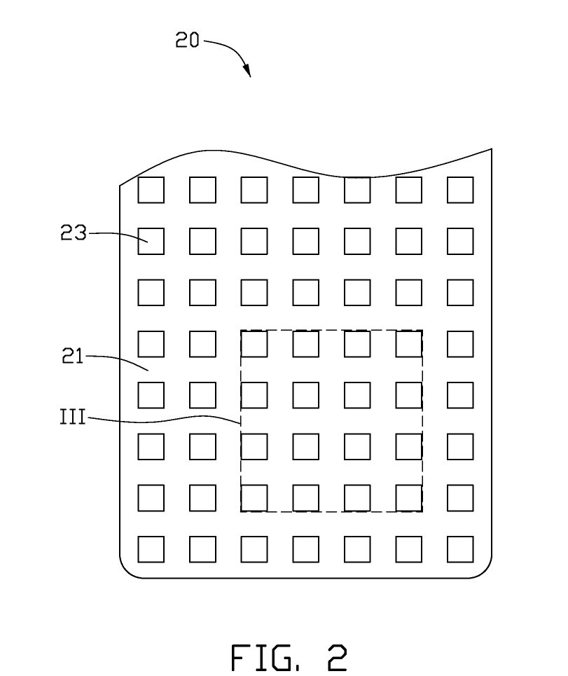

Referring to FIG. 2, a housing 20 is provided and can made of metal materials such as aluminum, aluminum alloy, titanium, titanium alloy, stainless steel, etc. Alternatively, the housing 20 can be made of plastic materials. The housing 20 includes a spaced first wire forming area 21 corresponding to the first lightproof area 11 in shape and size and a plurality of first shielding areas 23 corresponding to the first light-transmissible areas 13 in shape and size. The housing 20 has light-sensitive inks (not shown) printed on the surface to cover the first wire forming area 21. The first shielding areas 23 can be solidified through light irradiation, and securely affixed to the housing 20. The solidified light-sensitive inks can have excellent friction resistance, and resistant to scrapes when wiredrawing.

The first film 10 is placed on the surface of the housing 20. The first lightproof area 11 of the first film 10 overlaps the first wire forming area 21, and the first light-transmissible areas 13 overlaps the first shielding areas 23. By radiating light on the first film 10, the light-sensitive inks on the first light-transmissible areas 13 are solidified by the light passing through the first light-transmissible areas 13. The light-sensitive inks on the first lightproof area 11 remain un-solidified.

The first film 10 is then removed from the housing 20 to clean the surface of the housing 20. At this stage, the un-solidified light-sensitive inks are cleansed from the housing 20, and the first wire forming area 21 of the housing 20 is exposed to outside. The first shielding areas 23 of the housing 20 are covered by the solidified light-sensitive inks.

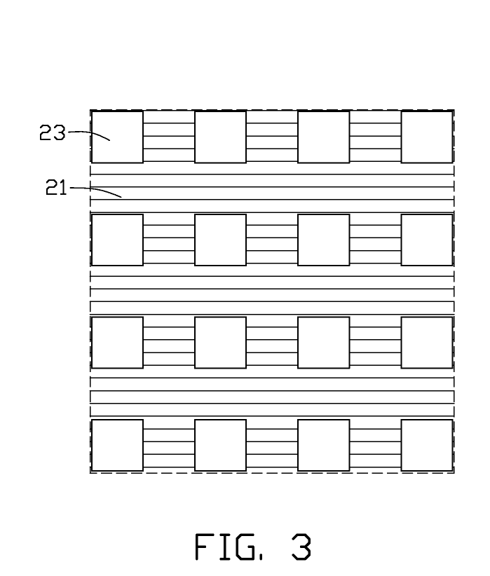

A plurality of first wires can be wiredrawn in the surface of the housing 20 by a wiredrawing machine. FIG. 3 shows a portion of the surface of the housing 20 after this wiredrawing. The first wire forming area 21 of the housing 20 is exposed with a plurality of first wires formed thereon. Due to the first shielding areas 23 being covered by the solidified light-sensitive inks, the first shielding areas 23 prevent from the first wires being formed on the first wire forming area 21. The wiredrawn first wires can be oriented according to desired requirements. Presently, the wiredrawn first wires are arranged transversely and evenly.

The solidified light-sensitive inks are cleansed from the surface of the housing 20 after wiredrawing the first wires. During this process, the solidified light-sensitive inks can be thoroughly removed by putting the housing 20 down into an organic solvent to dissolve the solidified light-sensitive inks. Another light-sensitive inks are printed on the surface of the housing 20, covering the first wire forming area 21 and the first shielding areas 23.

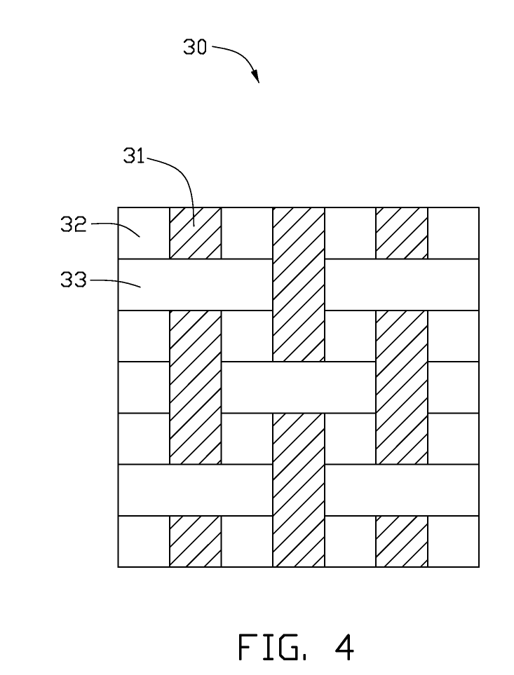

FIG. 4 shows a second film 30 corresponding to the surface of the housing 20 shown in FIG. 3. The second film 30 includes a plurality of second lightproof areas 31, second light-transmissible areas 32 and third light-transmissible areas 33. The second lightproof areas 31 correspond to part of the first wire forming area 21 of the housing 20 and are used to partially cover the first wire forming area 21. The second light-transmissible areas 32 arranged in a matrix correspond to the first shielding areas 23 of the housing 20 in shape and size. The third light-transmissible areas 33 correspond to the remainder part of the first wire forming area 21 of the housing 20 and are used to cover the remainder of the first wire forming area 21. The second lightproof areas 31 have light sensitive materials adhered thereto, such as opaque light sensitive glues. The second and third light-transmissible areas 32, 33 are transparent excluding light sensitive materials.

The second film 30 covers the surface of the housing 20 having the first wires. The second lightproof areas 31 partially overlap the first wire forming area 21 of the housing 20, the second light-transmissible areas 32 overlaps the first shielding areas 23 of the housing 20, the third light-transmissible areas 33 overlaps the remainder of the first wire forming area 21 of the housing 20. A light is irradiated onto the second film 30, enabling the light-sensitive inks of the second and the third light-transmissible areas 32, 33 to be solidified by the light passing through the second and the third light-transmissible areas 32, 33 and securely affixed to the housing 20. The light-sensitive inks of the first lightproof area 31 prevents from being solidified because no light can pass through the first lightproof area 31.

During removing the second film 30 from the housing 20 and cleaning of the surface of housing 20, the light-sensitive inks of the second lightproof areas 31 are cleansed from the housing 20, and the first wire forming area 21 corresponding to the second lightproof areas 31 are exposed to outside. The first shielding areas 23 corresponding to the second light-transmissible areas 32 and the first wire forming area 21 corresponding to the second light-transmissible areas 32 remain covered by the solidified light-sensitive inks.

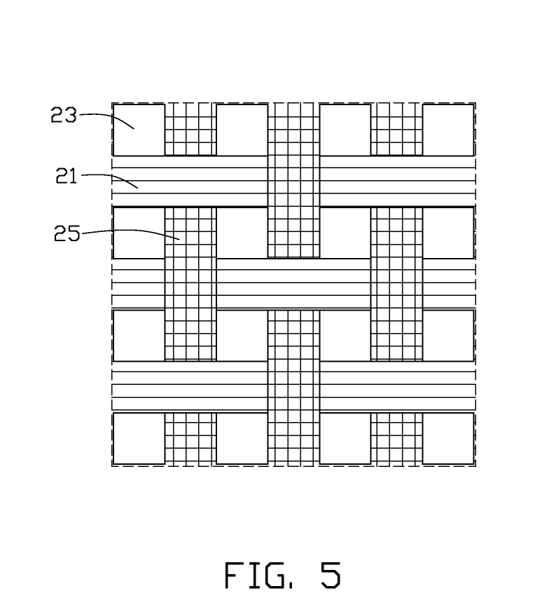

Referring to FIG. 5, the second wires are wiredrawn in the surface of the housing 20 by the drawing machine. The first wire forming area 21 corresponding to the second lightproof areas 31 is exposed with a plurality of second wires formed thereon. The second wires are crossed with the first wires, cooperatively forming a knit-like pattern in the surface of the housing 20. The first shielding areas 23 and the first wire forming area 21 corresponding to the second light-transmissible areas 32 have no second wires formed thereon.

After that, the solidified light-sensitive inks of the first shielding areas 23 and the first wire forming area 21 corresponding to the second light-transmissible areas 32 are cleansed from the surface of the housing 20. The cleaning method is similar to the cleaning method as above described, except that the housing 20 can be finally cleaned by water.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A method to fabricate a pattern on a housing, comprising:
providing a film having a lightproof area and a light-transmissible area;
providing a housing having light-sensitive inks formed thereon;
placing the film on the housing and radiating the film by a light, the light passing through the light-transmissible area of the film and solidifying the light-sensitive inks;
removing the film from the housing;
cleaning un-solidified light-sensitive inks from the housing to expose areas corresponding to lightproof areas;
wiredrawing first wires in the housing and forming first wires on the expose areas covering part of the area forming the first wires, wiredrawing second wires in the housing and forming the second wires in the housing, the second wires crossing with the first wires uncovered.

2. The method to fabricate a pattern on a housing, as claimed in claim 1, wherein after drawing the first wires, solidified light-sensitive inks are cleaned from the housing.

3. The method to fabricate a pattern on a housing, as claimed in claim 2, wherein after cleaning off the solidified light-sensitive inks, new light-sensitive inks are printed in the housing integrally.

4. The method to fabricate a pattern on a housing, as claimed in claim 3 wherein after printing new light-sensitive inks into the surface of the housing, a second film is provided, the second film includes a plurality of second lightproof areas and light-transmissible areas, the lightproof areas covers part of the first wires after the second film is covered the housing.

5. The method to fabricate a pattern on a housing, as claimed in claim 4 wherein after the second film is covered by the new light-sensitive inks, the second film is irradiated by light, the new light-sensitive inks corresponding to light-transmissible areas are solidified and affixes to the housing, the new light-sensitive inks corresponding to the lightproof areas are un-solidified.

6. The method to fabricate a pattern on a housing, as claimed in claim 5 wherein after the second film is irradiated, the un-solidified light-sensitive inks are cleansed and the second wires are wiredrawn in the housing.

7. The method to fabricate a pattern on a housing, as claimed in claim 1 wherein the housing is made of metal materials such as aluminum, aluminum alloy, titanium, titanium alloy, stainless steel etc.

8. The method to fabricate a pattern on a housing, as claimed in claim 1 wherein the housing includes a first wire forming area corresponding to the lightproof area of the film, and a shielding area corresponding to the transmit-area of the film.

9. The method to fabricate a pattern on a housing, as claimed in claim 1 wherein the lightproof area of the film has sensitive material adhered.

10. A method to fabricate a pattern on a housing, comprising:
providing a first film having a first lightproof area and a first light-transmissible area;
providing a housing having light-sensitive inks formed thereon;
placing the first film on the housing and radiating to the first film by light, the light passing through the light-transmissible area of the first film and solidifying the light-sensitive inks;
removing the first film from the housing, cleaning the un-solidified light-sensitive inks of the housing to expose the areas corresponding to lightproof areas;
wiredrawing and forming first wires in the exposed area correspondingly;
cleaning the solidified light-sensitive inks and printing new light-sensitive inks in the housing;
providing a second film having a second lightproof area and light-transmissible areas;
placing the second film on the housing, the light-transmissible areas covering part of the area forming the first wires,
radiating the second film by light, the light passing through the light-transmissible area of the second film and solidifying the light-sensitive inks;
removing the second film from the housing, cleaning the un-solidified light-sensitive inks from the housing;
wiredrawing second wires in the housing and forming the second wires crossing with the first wires.

11. The method to fabricate a pattern on a housing, as claimed in claim 10 wherein the housing is made of metal materials such as aluminum, aluminum alloy, titanium, titanium alloy, stainless steel and so on.

12. The method to fabricate a pattern on a housing, as claimed in claim 10 wherein the housing includes a first wire forming area and a shielding area corresponding to the lightproof area and the transmit-area of the first film respectively.

13. The method to fabricate a pattern on a housing, as claimed in claim 12 wherein the second lightproof areas correspond to part of the first wire forming area of the housing and are used to partially cover the first wire forming area.

14. The method to fabricate a pattern on a housing, as claimed in claim 13 wherein the second film includes a second light-transmissible areas and a third light-transmissible areas, the second light-transmissible areas, the second light-transmissible areas arranged in a matrix correspond to the first shielding areas of the housing in shape and size, the third light-transmissible areas correspond to the remainder part of the first wire forming area of the housing and are used to cover the remainder of the first wire forming area.
